(19) United States
(12) Patent Application Publication
(10) Pub. No.: US 2012/0025068 A1
(43) Pub. Date: Feb. 2, 2012

(54) Mass Spectrometry

(75) Inventors: Malcolm Clench, South Yorkshire (GB); Sally Atkinson, South Yorkshire (GB); Keith Oakes, Oxford Oxfordshire (GB)

(73) Assignee: SHEFFIELD HALLAM UNIVERSITY, Shedffield, South Yorkshire (GB)

(21) Appl. No.: 12/994,684

(22) PCT Filed: May 18, 2009
(86) PCT No.: PCT/GB2009/050532

§ 371 Date: May 27, 2011

(30) Foreign Application Priority Data
May 29, 2008 (GB) 0809768.5
Jun. 16, 2008 (GB) 0810917.5

(51) Int. Cl. H01J 49/10

(52) U.S. Cl. 250/282; 250/288

(57) ABSTRACT

Matrix-assisted laser desorption/ionisation mass spectrometry imaging (MALDI-MSI) apparatus and method comprising a laser and a multimode optical fiber to deliver a laser beam to a MADLI ion source. A vibration coupling is provided at a region along the length of optical fiber to impart an oscillatory vibrational motion at the optical fibre to move the irradiation intensity maxima at the sample to increase the effective irradiation surface area. The present apparatus and method provide increased imaging sensitivity and a corresponding reduction in data acquisition times.

The present invention relates to mass spectrometry and in particular, although not exclusively, to matrix-assisted laser deposition/ionisation mass spectrometry (MALDI-MS) in which a laser beam is delivered to a target by a multimode fiber optic feed.

Matrix-assisted laser desorption/ionisation (MALDI) is a highly adaptable soft ionisation technique for mass spectrometry (MS). It was developed in the late nineteen eighties and whilst MALDI-MS has found most application in proteomics, its versatility has been extended in recent years by the advent of protein profiling and imaging directly from the surface of thin biological tissue sections.

The use of mass spectrometry to obtain images started with the advent of secondary ion imaging mass spectrometry (SIMS). In imaging SIMS the surface of the sample is bombarded with high energy ions leading to the ejection (or sputtering) of neutral and charged species from the surface. The ejected species may include atoms, clusters of atoms and molecular fragments. In traditional SIMS it is only the positive ions that are mass-analysed. Since the technique utilises a beam of atomic ions (i.e. charged particles) as the probe, it is a relatively easy matter to focus the incident beam and then to scan it across the surface. The detector response for a selected mass at raster spot becomes a pixel in the image. The use of an ion beam results in sub-micron spatial resolution.

Imaging SIMS has been used in a range of pharmaceutical applications including monitoring drugs at the cellular and sub-cellular level. New developments apply SIMS to organic compounds and metabolites of low mass (<500 u) in biological samples. However, a major limitation is the mass range that may be analysed by this technique.

The initial step in MALDI-MS imaging involves application of a thin layer of matrix to the sample. The chemistry of the sample is then imaged by moving the sample under a stationary laser and acquiring mass spectra from each point. Three-dimensional images may be obtained by plotting the spatial dimensions of x and y versus absolute ion abundance, which is considered to be proportional to analyte concentration.

A further development of MALDI-MS involves the shaping and delivery of the beam from the laser medium to the sample using a fiber optic feed. Typically, a single multimode fiber optic is used which generates multiple light paths by internal reflectance. The fiber optic serves to shape the profile into spatially modulated intensities distributed on the sample surface. Without the spatial shaping, the beam intensity on the sample, as with conventionally used solid state lasers, exhibits a Gaussian or near Gaussian distribution having a single maximum (intensity peak).

However, whilst the multimode fiber optic feed provides multiple intensity peaks on the sample, the sensitivity and speed of data acquisition is limited to the physical configuration of the fiber optic.

GB 2422954 discloses a MALDI based laser system configured to generate a pulsed laser beam that a spatially shaped such that the spatial intensity distribution on the sample exhibits more than one intensity peak. Optical or electro optical components are disclosed for spatially shaping the intensity of the laser beam and comprise a lens array, digital optical elements or masks that completely or partially absorb, reflect or scatter the laser beam at central points. The optical or electro optical components may be adjusted to create different spatial intensity distributions of the beam at the sample.

However, the laser system of GB 2422954 typically necessitates considerable data acquisition periods, of the order of four to ten hours, and importantly provides limited sensitivity.

What is required is MALDI-MS apparatus that provides increased sensitivity and a reduction in data acquisition time with possible improvements to resolution when implemented in imaging mass spectrometric analytical methods (IMS).

The present invention provides an analytical system utilising mass spectrometry providing enhanced sensitivity with a corresponding reduction in the data acquisition time over current mass spectrometry techniques. In particular, the present invention provides apparatus and method for use in MALDI-MS suitable for imaging a wide variety of non-biological and biological samples. According to specific implementations, an order of magnitude increase in sensitivity is observed over current MALDI imaging techniques.

The inventors have found that by vibrating a region of the optical fiber, used to deliver the laser beam to the sample/ion source, the intensity maxima are repeatedly displaced at the sample thereby increasing the degree of sample ionisation within a single pixel boundary.

The present invention utilises a multimode optical fiber, and in particular a single multimode fiber configured to spatially distribute the laser beam when delivered to the sample to generate a plurality of intensity maxima. By modulating the optical fiber using suitable vibration means the plurality of intensity maxima are effectively multiplied to increase the surface area of sample irradiation.

The present invention also comprises alternative means and method to generate a plurality of intensity maxima at the sample together with means to perturb the speckle generation so as to multiply the intensity maxima incident at the sample.

According to a first aspect of the present invention there is provided a mass spectrometer comprising a means for producing a laser beam, a multimode optical fiber to deliver the laser beam to an ion source and a vibration means configured to cause the optical fiber to vibrate such that the spatial intensity distribution of the laser beam at the ion source exhibits more than one intensity peak.

The present invention is suitable for use with a wide variety of different lasers adapted to provide a desired wavelength, typically of the order of 200 to 360 nm. According to one specific implementation, the laser is neodynium doped yttrium ortho vanadate Nd:YVO4 which is frequency tripled to give a wavelength of 355 nm. Alternative lasers include, by way example, neodymium doped yttrium aluminium garnet (Nd:YAG) In particular, and as will be appreciated by the skilled in the art, specific implementations of the present invention may comprise YAG, vanadate, yittruim lithium fluoride (YLF) with the active ion comprising neodymium, ytterbium or other host and active ion(s) combinations with or without various means of frequency conversion such as non linear crystal(s) designed to provide laser outputs at the appropriate wavelength(s).

The means by which the optical fiber is oscillated/vibrated may comprise any mechanical, electronic, sonic or air displacement based device being physically coupled or non-coupled with the optical fiber and designed to impart an oscillatory movement in the fiber optic in a direction transverse or perpendicular to its longitudinal axis. Example vibration means include an electric motor, a piezoelectric switch or speaker system designed to generate a tactile sonic pulse at the region of the fiber optic so as to induce movement.

As will be appreciated by those skilled in the art, the present mass spectrometer comprises three fundamental components, namely an ionisation source, an analyser and a detector. Preferably, the present system comprises a hybrid quadrupole type-of-flight analyser with a suitable detector system for use with a MALDI ionisation source, in particular an orthogonal MALDI (oMALDI) ion source.

Preferably, the vibration means is mounted at the mass spectrometer at a region towards one end of the optical fiber in close proximity to the ion source/sample chamber or sample support. In particular, it has been found advantageous to mount the vibration coupling approximately 1 to 5 cm from the region where the fiber optic is physically coupled towards the sample chamber. As will be appreciated by those skilled in the art, the vibration means may be positioned at any region along the length of the optical fiber so as to impart an oscillatory movement serving to physically move the intensity maximum at the MALDI ion source.

A specific implementation of the invention will now be described by way of example only, and with reference to the accompanying drawings in which:

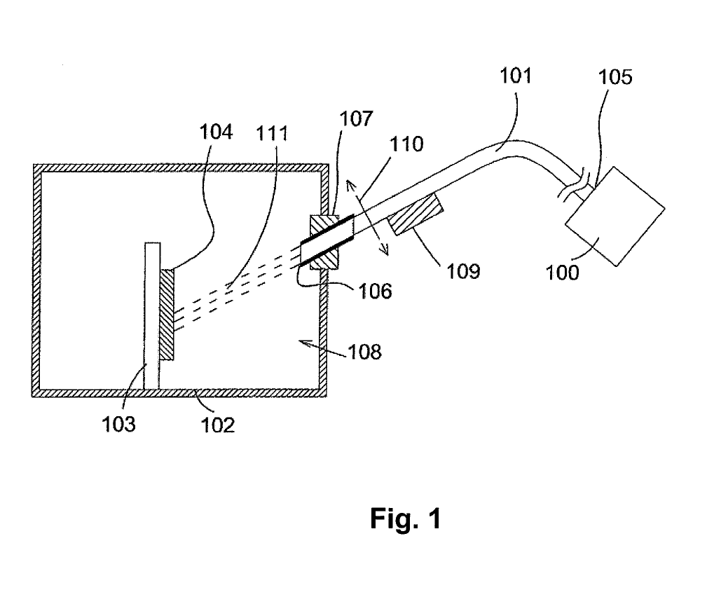

FIG. 1 illustrates schematically a mass spectrometer comprising a vibration coupling positioned at the optical fiber to impart an oscillatory movement in a direction transverse to its longitudinal axis according to a specific implementation of the present invention;

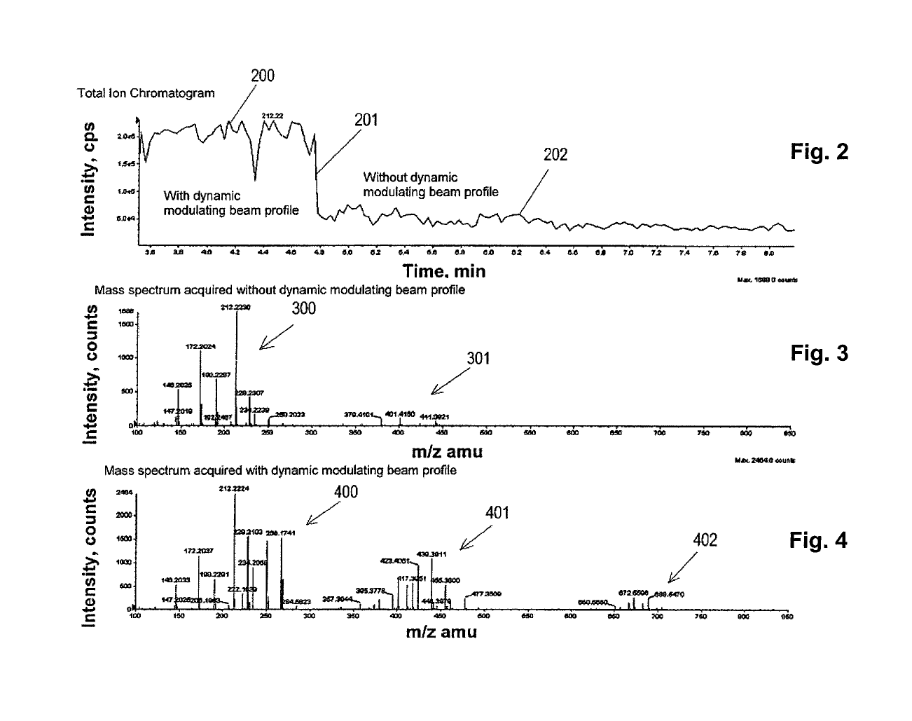

FIG. 2 illustrates an ion chromatograph of intensity vs time with the mass spectrometer of FIG. 1 operating in a dynamic modulating mode with the vibration means active and according to a second mode with the vibration means inactive to contrast the MALDI sample ionisation intensity;

FIG. 3 illustrates a mass spectrum acquired with the vibration means active to impart optical fiber modulation according to the first and highest intensity region of FIG. 2;

FIG. 4 illustrates a mass spectrum acquired with the vibration coupling inactive according to the second and lower intensity region at FIG. 2.

The mass spectrometer comprises a laser 100 (based on a medium such as Nd:YVO4) coupled to an optical fiber 101 at a first end 105. A second end 106 of fiber 101 is coupled to a sample housing 102 via a suitable screw thread type coupling 107. The delivery end 106 of the optical fiber 101 is orientated so as to irradiate a region of a sample/MALDI ion source 104 mounted at a suitable sample support 103 within an internal chamber 108 of housing 102.

A vibration coupling 109 is coupled to the optical fiber 101 towards beam delivery end 106 and approximately 1 to 5 cm from end 106. Vibration means 109 may be supported and mounted within the spectrometer using suitable mountings (not shown) so as to be physically coupled to an exterior surface of the fiber 101. According to further specific implementations of the present invention, vibration coupling 109 is not physically coupled to the external surface of optical fiber 101 but imparts an oscillating movement via a medium surrounding the external surface of the optical fiber 101 being a fluid, in particular air. In particular, vibration means 109 may comprise an air pump or speaker system designed to direct air pulses towards the external surface of fiber 101.

In use, and with vibration coupling 109 active, fiber optic 101 is forced to oscillate back and forth along direction 110 aligned transverse, in particular perpendicular, to the longitudinal axis of optical fiber 101.

Oscillating movement 110 at the region of vibration coupling 109 is transmitted along the length of optical fiber 101 to result in proportionally smaller movement oscillations at irradiation end 106. This has the effect of physically moving the irradiation intensity maximum at sample surface 104. Vibration coupling 109 is configured such that the movement modulation of optical fiber 101 at end 106 is sufficient to cause the intensity maxima to be displaced only within a single pixel of approximate dimensions 150×100 μm. Due to the enhanced sensitivity of the present mass spectrometer arrangement, the inventors provide a system capable of enhanced resolution with pixel dimensions of the order of 25×25 μm.

### Investigation by MALDI Mass Spectrometry Imaging

A comparative investigation was undertaken to determine the effect on MALDI-MSI instrument sensitivity with vibration coupling 109 in an active and a non-active mode. The results are presented in FIGS. 2 to 4.

The mass spectrometric analysis was performed using an API ‘Q-Star’ Pulsar i hybrid quadrupole time-of-flight instrument from Applied Biosystems/MDS Sciex (Concord, Ontario, Canada), fitted with an orthogonal MALDI source and ‘o-MADLI Server 4.0’, ion imaging software. Image processing was carried out using BioMap imaging software (www.maldi-msi.org).

A neodynium doped yittruim ortho vanadate (Nd:YVO4) laser was used with a laser spot of approximate dimensions 150×100 μm. Images were acquired at 200 μm increments with an ablation time for each spot of approximately 2 s, using 30% laser power and a laser repetition rate of 1 kHz (although higher or lower frequencies could be used). A beta test version of the applied Biosystems/MDS Sciex ‘Dynamic Pixel’ MALDI MSI acquisition mode was used for all studies.

FIG. 2 illustrates the total ion chromatograph with vibration coupling 109 active to modulate the beam profile (region 200) and inactive without optical fiber 101 vibrated in direction 110 (region 202). FIG. 2 illustrates the difference in intensity of the resultant sample ionisation due to the sample surface area irradiation as optical fiber end 106 moves back and forth whilst sample 104 is irradiated. As illustrated in FIG. 2, the intensity difference between region 200 and region 202 is approximately one order of magnitude. The sharp transition region 201 corresponds to the termination of power to the mechanical vibration coupling 109 resulting in a sharp decrease in intensity.

FIG. 3 illustrates in mass spectrum acquired with vibration coupling 109 inactive accordingly to region 202 of FIG. 2.

FIG. 4 illustrates a mass spectrum acquired with coupling 109 active according to region 200 of FIG. 2 utilising the same MALDI ionisation source and instrument parameters as used in the investigation of FIG. 3.

Referring to FIGS. 3 and 4 ionisation data appears only at regions 300 and 301 with vibration coupling 109 inactive. In contrast, the intensity profile is increased significantly with coupling 109 active to irradiate a greater sample surface area according to intensity regions 400 and 401. In particular, due to the increased sensitivity of the present invention, data is acquired at region 402 with this data not being available with the arrangement of FIG. 3.

1. A mass spectrometer comprising:
a means for producing a laser beam;
a multimode optical fiber to deliver the laser beam to an ion source; and
a vibration means configured to cause the optical fiber to vibrate such that the spatial intensity distribution of the laser beam at the ion source exhibits more than one intensity peak.

2. The mass spectrometer as claimed in claim 1 wherein the vibration means comprises a mechanical vibration device.

3. The mass spectrometer as claimed in claim 1 wherein the vibration means comprises a piezoelectric switch.

4. The mass spectrometer as claimed in claim 1 wherein the vibration means is physically coupled to the optical fiber.

5. The mass spectrometer as claimed in claim 1 wherein the vibration means comprises means to generate air waves at the region of the optical fiber to cause the optical fiber to vibrate.

6. The mass spectrometer as claimed in claim 1 wherein the means for producing the laser beam comprises a gain medium comprising any one or a combination of the following set of:
YAG;
Yttrium ortho vanadate;
Yttrium lithium fluoride.

7. The mass spectrometer as claimed in claim 6 wherein the means for producing the laser beam further comprises any one or a combination of the following set of:
Neodynium
Ytterbium.

8. The mass spectrometer as claimed in claim 6 wherein the means for producing the laser beam further comprises one or more non linear crystals for frequency conversion.

9. The mass spectrometer as claimed in claim 1 further comprising a sample chamber, the fiber optic being coupled to the sample chamber so as to direct the laser beam into an interior of the sample chamber.

10. The mass spectrometer as claimed in claim 9 wherein the vibration means is arranged so as to vibrate the fiber optic at a region along its length at a distance in the range 1 to 5 cm from the sample chamber.

11. An imaging mass spectrometer as claimed in claim 1.

12. A matrix-assisted laser desorption/ionisation mass spectrometer as claimed in claim 1.

13. A method of delivering a laser beam to a sample as part of matrix-assisted laser desorption/ionisation mass spectrometry comprising:
producing a laser beam;
delivering the laser beam to an ion source using a multimode optical fiber; and
vibrating the optical fiber at a region along its length using vibration means such that the spatial intensity distribution of the laser beam at the ion source exhibits more than one intensity peak.

14. A method of mass spectrometry imaging as claimed in claim 13.
